(19) United States
(12) Patent Application Publication
(10) Pub. No.: US 2025/0276623 A1
(43) Pub. Date: Sep. 4, 2025

(54) CRASH DEVICE FOR A VEHICLE SEAT

(71) Applicant: Brose Fahrzeugteile SE & Co. Kommanditgesellschaft, Coburg, Coburg (DE)

(72) Inventor: Jürgen SCHUKALSKI, Küps (DE)

(21) Appl. No.: 19/054,607

(22) Filed: Feb. 14, 2025

(30) Foreign Application Priority Data
Feb. 29, 2024 (DE) 10 2024 105 888.9

(51) Int. Cl. B60N 2/427

(52) U.S. Cl. CPC B60N 2/42781

(57) ABSTRACT

It is provided a crash device, in particular for a vehicle seat, comprising: a first and a second bearing point for connecting one component each, and a carrier on which the first bearing point is formed and which includes a guide for guiding a movement of the second bearing point relative to the first bearing point, wherein in a starting position the second bearing point is arrested by an arresting element which is locked by means of a locking device and after unlocking of the locking device can be plastically deformed by a movement of the second bearing point along the guide.

### CROSS REFERENCE TO RELATED APPLICATION

The present application claims priority to German Patent Application No. 10 2024 105 888.9 filed on Feb. 29, 2024. The entire contents of the above-listed application are hereby incorporated by reference for all purposes.

### BACKGROUND

The proposed solution relates to a crash device and a vehicle seat comprising such a crash device.

In a vehicle crash large forces can act on a vehicle seat and the passenger sitting thereon. DE 10 2021 202 560 A1 describes a lever with a deformation section, which in a vehicle crash can reduce loads due to a deformation of the deformation section and thus provides for slowing down the passenger more gently.

Furthermore, vehicle seats can be adjustable, e.g. in order to provide each of various seat users with a comfortable seating position and to be adapted to various spatial conditions. For example, a vehicle seat can be mounted in a vehicle so as to be longitudinally adjustable by means of a longitudinal adjustment device, in order to provide for various seating positions along the longitudinal vehicle axis, a vehicle seat can be adjustable by means of a height adjustment device, in order to adjust a seat height, and in a vehicle seat the inclination of a backrest can be adjustable relative to a seat part, in order to name only a few examples. The lever described in DE 10 2021 202 560 A1 is part of a seat height adjustment of the vehicle seat and hence fulfills a dual purpose.

To provide a particularly comfortable seating position for passengers, and in autonomously driving vehicles also for drivers, during the ride, vehicle seats can be designed such that they can be transferred into a relax position in which a seat part and a backrest are inclined far to the rear. In such a position, which in particular can represent a reclined position, the passenger can lie and e.g. sleep comfortably. In such a position of the vehicle seat, however, high forces would be introduced into the spine in the case of a front crash due to the restraint of the pelvis of the seat user. Depending on the concrete configuration of the vehicle seat, this can result in an increased risk of injury of the seat user. In such a seat position, the reduction of crash energy and/or the transfer into a position to be cushioned more easily therefore can be particularly advantageous.

### SUMMARY

It is the object to indicate a crash device improved further.

This object is achieved by a crash device having features as described herein.

Accordingly, there is indicated a crash device, in particular for a vehicle seat. The crash device comprises a first bearing point and a second bearing point, each for connection of a respective component (external with respect to the crash device), for example of a respective component of the vehicle seat. The crash device furthermore comprises a carrier, on which the first bearing point is formed and which includes a guide for guiding a movement of the second bearing point relative to the first bearing point. It is provided that in a starting position the second bearing point is arrested by an arresting element which is locked by means of a locking device and after unlocking of the locking device can be deformed (in particular plastically) by a movement of the second bearing point along the guide.

By means of the locking device, a movement of the second bearing point along the guide can selectively be prevented or enabled. In this way, the locking device can be unlocked e.g. in dependence on the seating position, the acting acceleration or the detection of a vehicle crash, so that it is possible to choose the behavior of the crash device optimal for the respective situation. In a vehicle seat comprising one or more of such crash devices, the vehicle seat thereby can be moved into another position, e.g. into a position in which the remaining forces can be absorbed more easily. Concretely the vehicle seat can be transferred e.g. from the relax position (or another, in particular rearwardly inclined starting position) into a more upright position by comparison, so that the acting forces can be introduced over a larger surface area via a seat belt and a risk of “submarining”, i.e. slipping through under the seat belt, can be reduced distinctly. The load acting on the spine can be reduced thereby. One of the bearing points or both bearing points can be a pivot bearing or a part of a pivot bearing, wherein another kind of support also each is conceivable, such as an immovable, fixed support on one of the bearing points.

Since the arresting element is deformable in order to enable the movement (and e.g. a deformation of a deformation element, see below), a clearance-free support of the second bearing portion also is made possible. For example, no clearance is necessary for a rotatable or shiftable support of the arresting element or the like. As a result, an improved crash device thus is achieved and consequently an improved vehicle seat is made possible. In addition, an easy assembly is made possible, for example only a joining method is carried out, e.g. welding.

The crash device furthermore can comprise a deformation element which can be deformed by a movement of the second bearing point guided on the guide out of the starting position relative to the first bearing point. By means of the locking device, a deformation of the deformation element selectively can be prevented or enabled. For example in the case of a frontal impact of the vehicle, crash energy can be reduced by means of the deformation element in that material of the deformation elements is elastically and/or plastically deformed. The crash device hence can be a crash absorber.

It can be provided that the locking device and/or the arresting element each are mounted on the carrier in such a way that they cannot be moved without being destroyed. A force acting on the arresting element can be introduced for example via a first load path from the arresting element (in particular directly, e.g. via a contact between the arresting element and the carrier) into the carrier. The force can also be introduced via a second load path from the arresting element via the locking device in the locked state into the carrier. The arresting element can be weakened by opening the second load path by means of unlocking of the locking device. The locking device and the arresting element hence can be configured as non-movable parts, and the arresting element can be weakened in a targeted way by removing the second load path, in particular can be deformed in a targeted way (e.g. when the acting force exceeds a threshold value), instead of opening e.g. via a movable support. After unlocking of the locking device and the deformation of the arresting element, the same hence e.g. can no longer be transferred back into the locked starting position, as they are destroyed due to the plastic deformation.

The arresting element can be attached to the carrier, e.g. be welded to the carrier. In this way, a clearance between the arresting element and the carrier can be avoided.

It can be provided that the arresting element includes an area (e.g. arm) which encloses the second bearing point in the starting position. Furthermore, it can be provided that the arresting element can be deformed elastically and/or plastically due to the movement of the second bearing point along the guide. Such an area provides for a safe arrestment in the starting position and a controlled release of the bearing point in the case of a crash.

The locking device can comprise a locking element fixed to the carrier. It can be provided that the locking element in a locking position is in operative connection, in particular in engagement, especially in contact with the arresting element and/or can be transferred into an unlocking position (in particular by plastic deformation), in which the locking element is out of operative connection and/or engagement and/or contact with the arresting element. The arresting element thereby can be locked in a simple way in the position securing the second bearing point in the starting position. Unlocking can be effected with little expenditure of force and the arresting element yet can be safely protected against unwanted opening. By eliminating the operative connection or the engagement or the contact of the locking element, the second load path can be eliminated. The first load path is overloaded e.g. from a particular load such that the arresting element is deformed in a targeted way and the bearing point can move.

The locking element for example includes a receptacle. In the locking position, the receptacle can e.g. be positively in engagement with the area (e.g. arm) of the arresting element, in particular with an end of the area (e.g. arm). With a simple and robust construction, this provides for safe locking.

For example, the locking element can be transferred from the locking position into the unlocking position by a deformation of the locking element. Thus, a movable support of the locking element can (also) be omitted. A clearance in the support of the locking element can thereby be avoided. It can even be provided that in the locking position the locking element is pressed onto the area (e.g. arm) of the arresting element.

In some embodiments, the locking device comprises a trigger element. By means of the trigger element, the locking element can be transferable from the locking position into the unlocking position. In this way, a needs-based release of the deformation of the deformation element can be controlled.

The trigger element is configured e.g. in the form of a pyrotechnical actuator. The trigger element can comprise an igniter and a propellant charge ignitable by the igniter. This provides for a particularly fast release of the deformation element.

The guide defines a guideway, e.g. a linear or curved guideway, along which the movement of the second bearing point out of the starting position is guided relative to the first bearing point. It can be provided that the trigger element is adapted to exert a force on the locking element at an angle to the guideway. Such an arrangement allows safe locking. The angle can be a right angle. It can thus be prevented that even larger forces acting on the second bearing point do not lead to a deformation of the deformation element, as long as the locking device is not unlocked.

In some embodiments, the carrier forms a housing. In the housing, the arresting element can be arranged. The arresting element thus can be protected against external influences.

The carrier includes e.g. two housing sheets which can be welded to each other. Thus, a construction can be achieved, which can be manufactured particularly easily and is robust at the same time.

For example, the guide is configured in the form of an oblong hole and/or is formed in at least one of the housing sheets. This allows a particularly safe guidance.

It can be provided that the second bearing point comprises a bearing bush and/or a pin. In the starting position, the bush (or the pin) can be pressed into the arresting element. Thereby, a completely clearance-free support can be achieved.

The first bearing point and/or the second bearing point (each) can directly or indirectly be formed for a rotatable support. The crash device can be used e.g. as a swingarm in a height adjustment device or the like and thus fulfill a dual function.

Unlocking of the locking device e.g. is irreversible. This provides for a particularly simple and safe construction.

According to one aspect, there is indicated a vehicle seat (e.g. with a seat part and a backrest), comprising one or more crash devices according to any of the embodiments described herein. As regards the advantages, reference is made to the above indications.

It can be provided that the seat part (as one of the components) is supported on a base (as the other one of the components) via the crash device(s). Via the crash device(s), e.g. a weight of the seat part is supported on the base. The crash device (or the crash devices) thus can fulfill a dual function.

The (respective) crash device can be pivotally mounted on the base with one of the two bearing points. The seat part can be pivotally mounted on the other one of the bearing points. The crash device or the crash devices thus can be used e.g. as swingarms of an adjustment device.

It can be provided that the seat part is height-adjustably mounted relative to the base via the crash device(s). In normal use, the respective crash device hence can be used as swingarms of a height adjustment device and reduce crash energy in the case of a crash.

### BRIEF DESCRIPTION OF THE DRAWINGS

The idea underlying the solution will be explained in detail below with reference to the exemplary embodiments illustrated in the Figures.

FIG. 1 shows an adjustable vehicle seat with a seat part and a backrest.

FIG. 2 shows a crash device of the vehicle seat of FIG. 1 with a deformation element that can be deformed as a result of an action of force.

FIG. 3A shows a sectional view of the crash device of FIG. 2 in a starting position according to the sectional plane depicted in FIG. 3B.

FIG. 3B shows a side view of the crash device of FIG. 2 in the starting position.

FIG. 4A shows a sectional view of the crash device of FIG. 2 in a starting position according to the sectional plane depicted in FIG. 4B.

FIG. 4B shows a side view of the crash device of FIG. 2 in the starting position.

FIG. 5A shows a sectional view of the crash device of FIG. 2 according to the sectional plane depicted in FIG. 5B.

FIG. 5B shows a side view of the crash device of FIG. 2, wherein a locking device is unlocked and releases an arresting element of the crash device.

FIG. 6A shows a sectional view of the crash device of FIG. 2 according to the sectional plane depicted in FIG. 6B.

FIG. 6B shows a side view of the crash device of FIG. 2, wherein the arresting element of the crash device has been deformed due to a movement of a second bearing point of the crash device along a guide.

FIG. 7 shows a further crash device for the vehicle seat of FIG. 1.

FIGS. 8 and 9 show trigger elements for the crash device of FIG. 2.

FIG. 10 shows the deformation element of the crash device of FIG. 2.

### DETAILED DESCRIPTION

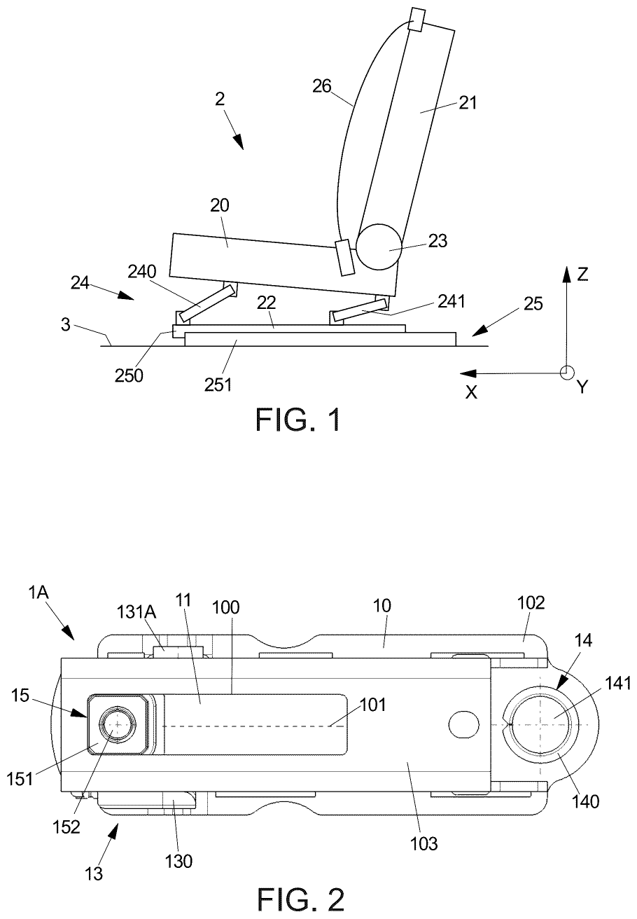

FIG. 1 shows a vehicle seat 2 comprising a seat part 20 and a backrest 21. The backrest 21 is arranged on a rear area of the seat part 20, in the present case pivotally mounted on the seat part 20 about a pivot axis by means of an arrangement of fittings 23.

The vehicle seat 2 furthermore comprises a height adjustment device 24 for adjusting the seat height of the seat part 20 (along with the backrest 21) relative to a base 22. The height adjustment device 24 (on each side, i.e. on the left and right) in a front area includes a front swingarm 240 and in a rear area a rear swingarm 241, via which the seat part 20 and here also the backrest 21 are supported on the base 22. The swingarms 240, 241 each are pivotally mounted on the base 22, and the seat part 20 is pivotally mounted on the swingarms 240, 241.

By adjusting the swingarms 240, 241 relative to the base 22, the seat height can be adjusted relative to the base 22 along a vertical vehicle axis Z.

In the present case, a seat rail 250 of a longitudinal adjustment device 25 of the vehicle seat 2 serves as a base 22. When the vehicle seat 2 e.g. is not equipped with the longitudinal adjustment device 25, e.g. a vehicle floor 3 or a component fixed thereto can serve as a base.

By means of the longitudinal adjustment device 25 the seat part 20 (jointly with the backrest 21) can be adjusted relative to the vehicle floor 3 along a longitudinal vehicle axis X. The longitudinal vehicle axis X extends perpendicularly to the vertical vehicle axis Z. The longitudinal vehicle axis X and the vertical vehicle axis Z each extend perpendicularly to a transverse vehicle axis Y. The pivot axes of the swingarms 240, 241 extend parallel to the transverse vehicle axis Y. The pivot axis of the backrest 21 extends parallel to the transverse vehicle axis Y relative to the seat part 20.

In the present example, the longitudinal adjustment device 25 comprises two floor rails 251 spaced along the transverse vehicle axis Y, of which in the side view of FIG. 1 the left floor rail 251 from the point of view of a seat user sitting on the vehicle seat 2 can be recognized. The corresponding right floor rail 251 is formed analogously to the left floor rail 251 (e.g. identically or mirror-symmetrically). This also applies for the swingarms 240, 241 of the height adjustment device 24 mentioned already.

The floor rails 251 can be mounted on the vehicle floor 3 of a vehicle and, in the mounted stated as shown in FIG. 1, are attached to the vehicle floor 3 of the vehicle comprising the vehicle seat 2. A respective seat rail 250 of the longitudinal adjustment device 25 is in engagement with each of the floor rails 251 so as to be longitudinally shiftable. The longitudinal adjustment device 25 connects the height adjustment device 24 to the vehicle floor 3.

FIG. 1 shows the vehicle seat 2 in an upright seating position, in which the seat user can drive the vehicle with the vehicle seat 2 e.g. as a driver. The vehicle seat 2 can also be adjusted into a relax position, in which the seat user can e.g. rest or sleep in the vehicle seat 2. In the relax position both the seat part 20 and the backrest 21 are inclined further to the rear as compared with the upright seating position (from the point of view of the seat user sitting on the vehicle seat 2 and looking straight ahead), namely in the present case to such an extent that a torso angle and/or an angle of a longitudinal axis of the backrest 21 with an alignment of the base 22 according to a mounted state are more than 25° (in particular more than 30°, more than 40° or even more than 50°) relative to the vertical vehicle axis Z (and in the vehicle placed on a horizontal ground relative to the vertical Z). The torso angle by way of example corresponds to the angle of a straight torso line of the torso from the hip joint to the shoulders of a seat user sitting in the vehicle seat 2 relative to the vertical vehicle axis Z (and/or relative to the vertical Z). The longitudinal axis of the backrest for example extends from the pivot axis of the backrest 21 on the seat part 20 up to the upper end edge of the backrest 21.

The measurement of the torso angle for example is effected with the standardized H-point measuring machine SAE J826 H-POINT MANIKIN according to E/ECE/324 and/or E/ECE/TRANS/505 (e.g. according to Regulation No. 14, REV. 1/ADD. 13/REF, 1, ANNEX 4).

The seat part 20 and the backrest 21 can be moved by means of the height adjustment device 24 from the upright seating position into the relax position inclined further to the rear, and vice versa.

In the present example, a belt exit point of a seat belt 26 for the seat user furthermore is arranged at an upper end (facing away from the seat part 20) of the backrest 21. A winding mechanism for the seat belt 26 is mounted e.g. on the backrest 21. By pulling on the seat belt 26 a force hence acts on the upper end of the backrest 21. Furthermore, a belt buckle is attached to the seat part 20 (alternatively e.g. to the seat rail 250).

In the case of a front crash, the weight of the seat user pulls on the backrest 21 via the seat belt 26 and exerts a force on the backrest 21. Furthermore, a force acts on the seat part 20 in the region of the belt buckle. The forces each are directed forwards and upwards. As in the relax position the torso of the seat user is inclined relatively far to the rear, e.g. at an angle of more than 35° relative to the vertical vehicle axis Z or even at an angle of more than 45° relative to the vertical vehicle axis Z, high forces would be introduced into the spine of the seat user in the case of a frontal impact.

The front swingarms 240 (alternatively or additionally the rear swingarms 241) therefore are configured in the form of crash devices 1A, as illustrated in FIG. 2. The front suspension of the seat part 20 thereby can be compressed, whereby in the case of a crash of the vehicle a movement of the seat part 20 and the backrest 21 comprising a rotation is guided from the relax position (or another position) into a comparatively more upright position.

As will be explained in more detail below, energy introduced into the vehicle seat 2 as a result of the crash is absorbed during this movement from the relax position into the more upright position. It should be noted already at this point that the described arrangement of the crash devices 1A merely is by way of example, and other or additional arrangements of such crash devices 1A on the vehicle seat 2 (e.g. on the longitudinal adjustment device 25 and/or on the fittings 23) or at some other point also are conceivable.

FIG. 2 shows one of the crash devices 1A of the vehicle seat 2. The crash device 1A can also be referred to as a deformable connecting member or as a holding part, according to the present example also as a swingarm. In the present example, the crash device 1A forms a crash absorber (for the absorption of crash energy).

The crash device 1A comprises a first bearing point 14 and a second bearing point 15, each for connection of a component, in the present case for the pivotable connection of the seat part 20 at one of the bearing points 14, 15 and of the base 22 at the other one of the bearing points 14, 15. The bearing points 14, 15 therefor each comprise e.g. a bolt and/or, as shown in FIG. 2, an opening 141, 152. In the present case, merely by way of example, the opening 141 of the first bearing point 14 formed as a through opening is provided with a sleeve 140 into which e.g. a bolt or the like can be plugged in order to be rotatably mounted in the sleeve 140. Likewise by way of example, the second bearing point 15 is equipped with a through opening into which a bolt or the like can be plugged. However, other embodiments also are possible as well. In the present case, the first bearing point 14 and the second bearing point 15 each are configured for rotatably mounting the respectively connected component. With the components (seat part 20 and base 22) connected according to FIG. 1, the two bearing points 14, 15 each form a pivot bearing.

The crash device 1A furthermore comprises a carrier 10 on which the first bearing point 14 is formed and which includes a guide 100 for guiding a movement of the second bearing point 15 relative to the first bearing point 14. The second bearing point 15 is mounted on the guide 100 so as to be shiftable along the guide 100. FIG. 2 shows the second bearing point 15 in a starting position. In the starting position, the second bearing point 15 is arranged at the end of the guide 100 facing away from the first bearing point 14.

The carrier 10 comprises two housing sheets 102, 103 welded to each other. In the present case, the housing sheets 102, 103 by way of example are stamped and bent parts. The guide 100 is configured in the form of an oblong hole in at least one of the housing sheets 102, 103, in the present case in the upper housing sheet 103.

The crash device 1A furthermore comprises a deformation element 11. The deformation element 11 can be deformed, in the present case plastically, by a movement of the second bearing point 15 out of the starting position relative to the first bearing point 14, which is guided on the guide 100. In the illustrated example, the second bearing point 15 can be moved towards the first bearing point 14, wherein the deformation element 11 is deformed, as will yet be explained further below.

It is provided that in the starting position the second bearing point 15 is arrested by an arresting element 12 which is locked by means of a locking device 13 and which after unlocking of the locking device 13 can be deformed by a movement of the second bearing point 15 along the guide 100 (simultaneously with the deformation element 11 or before the deformation of the deformation element 11).

In the illustrated example, the guide 100 is oblong. The guide 100 defines a guideway 101, which is linear according to FIG. 2, but might also be formed differently, e.g. arc-shaped, in particular according to a circular segment. The deformation element 11 is attached to the guide 100. The deformation element 11 extends along the guide 100. The deformation element 11 blocks the guide 100. In the guide 100, the second bearing point 15 is arranged.

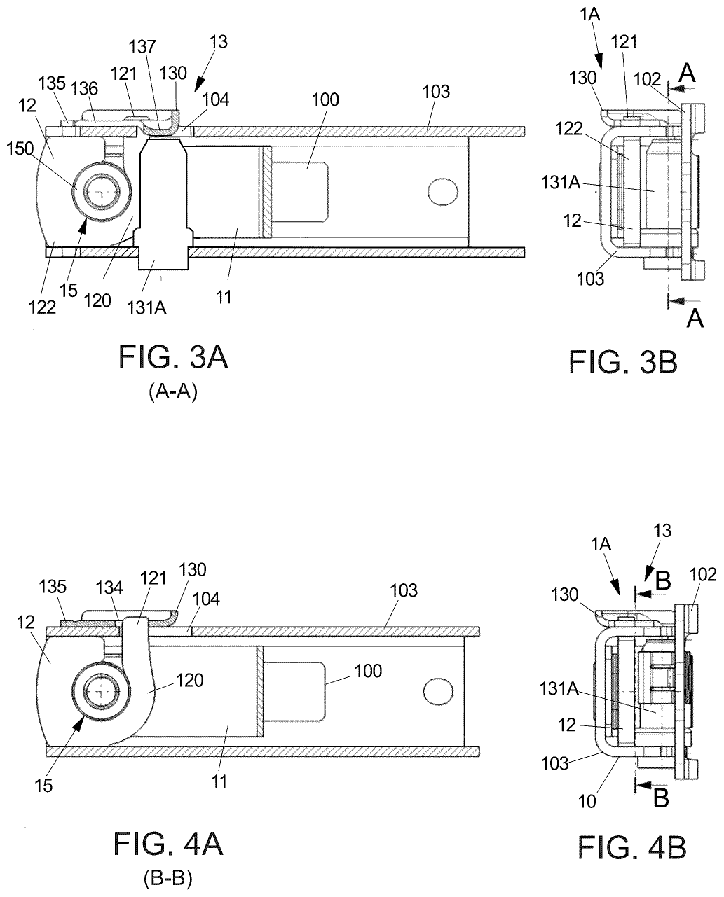

With respect to FIGS. 3A to 6B the function of the arresting element 12 and the locking device 13 will now be explained in detail.

FIGS. 3A to 4B show the starting position. The arresting element 12 encloses the second bearing point 15, namely in the present example almost once around its axis. The arresting element 12 includes a base 122 and an area, here by way of example in the form of an arm 120. The base 122 is arranged at an end of the crash device 1A facing away from the first bearing point 14. The base 122 of the arresting element 12 is arranged on the side of the second bearing point 15 which faces away from the first bearing point 14.

The arresting element 12 is arranged between the two housing sheets 102, 103. The housing sheets 102, 103 jointly form a housing for the arresting element 12, the deformation element 11 and some parts of the locking device 13. The arresting element 12 is firmly held at the carrier 10. In the present case, the arresting element 12 is fixed to the carrier 10, namely concretely welded thereto.

The arm 120 of the arresting element 12 extends around the second bearing point 15 and through an opening 104 of the carrier 10. In the present case, the opening 104 is formed in the upper housing sheet 103, namely in the present case in a side wall. An open end 121 of the arm 120 of the arresting element 12 is arranged outside the carrier 10. The arm 120 of the arresting element 12 blocks a movement of the second bearing point 15 along the guide 100. The arm 120 of the arresting element 12 arrests the second bearing point 15 in the starting position. As long as the arm 120 is in the position shown in particular with reference to FIG. 4A, a high (higher) force can be transmitted (than with an unlocked arresting element 12), without the second bearing point 15 being shifted along the guide 100.

To hold the arm 120 in this position, the arm 120 is held by the locking device 13. For this purpose, the locking device 13 comprises a locking element 130. The locking element 130 is fixed to the carrier 10. For this purpose, the locking element 130 includes a fastening area 135 which is attached to the carrier 10. In the present example, the fastening area 135 is welded to the carrier 10. The locking element 130 furthermore includes a receptacle 134. The end 121 of the arm 120 of the arresting element 12 is plugged into the receptacle 134. The direction along which the end 121 of the arm 120 of the arresting element 12 is plugged into the receptacle 134 is aligned perpendicularly to the guideway 101.

In the position shown in FIG. 4A, the second bearing point 15 is pressed (between base 122 and arm 120) into the arresting element 12 (e.g. without any clearance) and positively and non-positively held therein. The second bearing point 15 includes a bearing bush 150 (alternatively or additionally a pin), which here is plugged, preferably pressed into the arresting element 12, and here by way of example is of circularly cylindrical shape. Furthermore, the end 121 of the arm 120 of the arresting element 12 is pressed into the receptacle 134 in such a way that it rests against a side surface of the receptacle 134 under tension. The bearing bush 150 by way of example here includes an internal thread into which a bolt can be screwed. This bolt can form a pivot bearing. Alternatively or additionally, the bearing bush 150 can rotatably support the bolt.

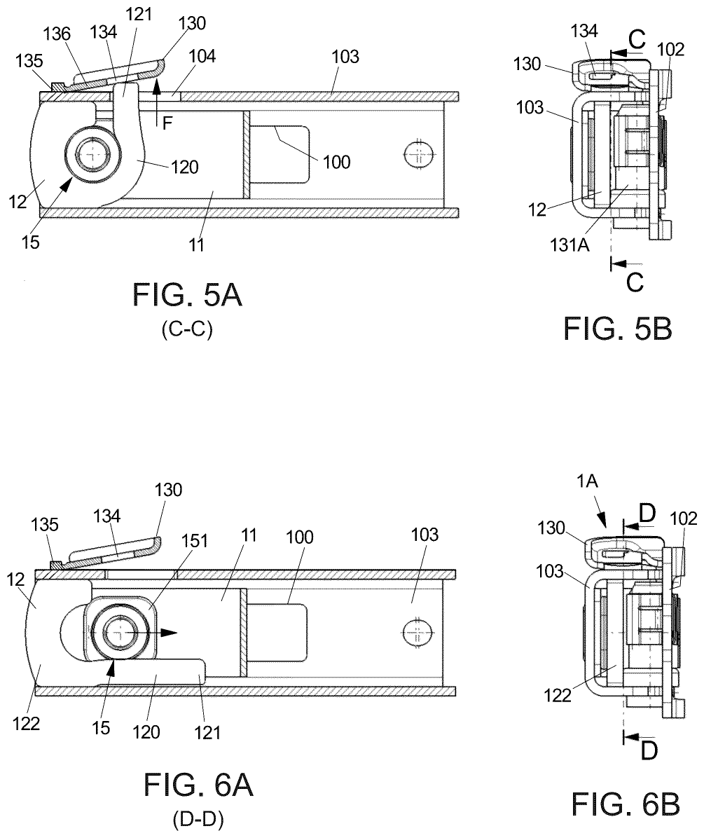

In its locking position, the locking element 130 is in engagement with the arresting element 12 and can be transferred into an unlocking position in which it is out of engagement with the arresting element 12. The unlocking position is illustrated in FIGS. 5A and 5B. Due to a deformation, the locking element 130 here has been transferred from the locking position into the unlocking position. In the process, a web 136 on which the receptacle 134 is formed is pivoted away from the carrier 10, namely in the present case bent up. Between the web 136 and the fastening area 135 a weakened portion of the locking element 130 is provided, at which the locking element 130 in the present case is bent up in the unlocking position.

To transfer the locking element 130 from the locking position into the unlocking position, the locking device 13 comprises a trigger element 131A. The trigger element 131A is aligned perpendicularly to the guideway 101. The trigger element 131A is arranged in the housing formed by the carrier 10. In the present case, the trigger element 131A is arranged adjacent to the second bearing point 15. The trigger element 131A extends adjacent to the arm 120 of the arresting element 12. In the present case, the trigger element 131A is aligned parallel to the arm 120. The trigger element 131A is plugged into a side wall of the carrier 10 and held on the same. A tip of the trigger element 131A is aligned with the locking element 130, namely in the present case concretely with a protrusion 137 which is extended into the opening 104 of the carrier 10 towards the trigger element 131A.

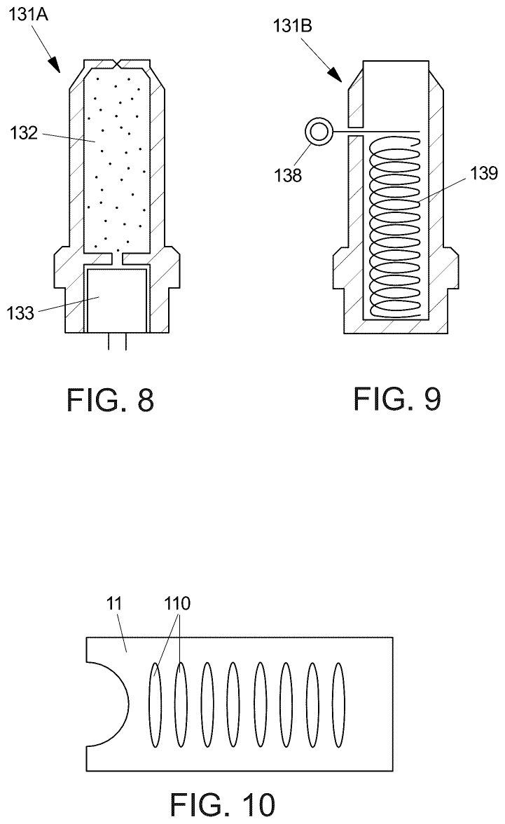

In the present example, the trigger element 131A is formed as shown in FIG. 8.

As shown in FIG. 8, the trigger element 131A is configured in the form of a pyrotechnical actuator with an igniter 133 and a propellant charge 132 to be ignited by the igniter 133. At the tip of the trigger element 131A, as shown, a predetermined breaking point can be formed. On ignition of the propellant charge 132 the trigger element 131A breaks up, concretely at the predetermined breaking point, and with combustion gases and/or a housing part and/or an optionally provided stamp or the like exerts a force F (see FIG. 5A) on the locking element 130, concretely on its protrusion 137. The locking element 130 thereby bends plastically (alternatively or additionally elastically) away from the carrier 10 and thus gets out of engagement with the arm 120 of the arresting element 12. The force F is aligned perpendicularly to the guideway 101.

At this point it should be noted that instead of the pyrotechnical actuator a differently configured trigger element can also be provided, e.g. the trigger element 131B as shown in FIG. 9. Accordingly, a spring accumulator with a pretensioned spring 139 is arranged in the interior of the trigger element 131B. A latch 138 or the like holds the spring 139 in the pretensioned position. An actuation of the latch 138 (here by pulling out) releases the spring 139 so that the same expands and exerts a force F on the locking element 130, which thereby releases the arm 120 of the arresting element 12 as described.

Unlocking of the locking device 13 consequently is irreversible, which provides for a simple and robust construction.

In the position shown in FIG. 5A, the arm 120 of the arresting element 12 thus still is arranged in the starting position, but can now be deformed (plastically), namely be bent up, by a force F directed towards the first bearing point 14 onto the second bearing point 15, see in particular FIG. 6A.

Here (or depending on the arrangement of the deformation element 11 thereafter) the deformation element 11 also is deformed and the second bearing point 15 is shifted along the guide 100. A slide 151 of the second bearing point 15 is in planar abutment with the edges of the guide 100. The arresting element 12 cannot be opened without being destroyed.

The locking device 13 and the arresting element 12 each are mounted on the carrier 10 in such a way that the locking element 130 and the area (here the arm 120) cannot be moved without being destroyed. A force on the arresting element 12 can directly be introduced into the carrier 10 via a first load path from the arresting element 12 and can be introduced into the carrier 10 via a second load path from the arresting element 12 via the locking device 13 disposed in the locked state. The arresting element 12 can be weakened by removing the second load path by means of unlocking of the locking device 13.

The trigger element 131A, 131B can be triggered by a control system. The control system can detect an imminent or effected crash and in response thereto activate the trigger element 131A, 131B. The control system optionally detects a position of the vehicle seat 2 and activates the trigger element 131A, 131B only in a specified position of the vehicle seat. The trigger element 131A, 131B can also be triggerable by an acting acceleration. The actuation of the trigger element 131A, 131B can be effected via a seat-integrated crash assessment, an acceleration sensor or an on-board crash assessment, and by detecting an imminent vehicle crash or by detecting a vehicle crash occurred already.

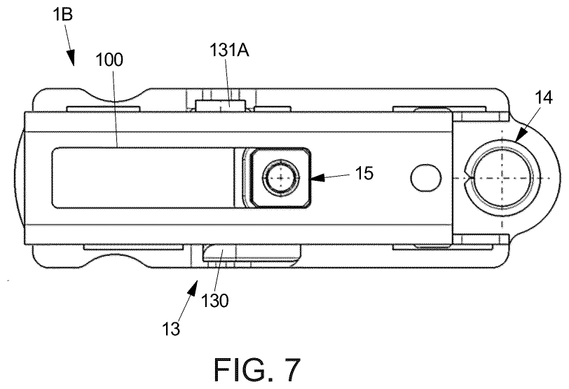

FIG. 7 shows a crash device 1B which the vehicle seat 2 can comprise alternatively or in addition. The mode of operation is the same as described above, merely the direction of the movement of the second bearing point 15 in the guide 100 is different, namely away from the first bearing point 14. The carrier 10 includes the correspondingly configured guide 100. Thus, the distance between the bearing points 14, 15 can be increased.

FIG. 10 shows the deformation element 11 separately in an exemplary embodiment. The deformation element 11 here includes weakened portions 110. The deformation element 11 is formed weaker than the housing sheets 102, 103. The weakened portions 110 can be configured in the form of apertures or indentations. The deformation element 11 allows a particularly precise and uniform deformation. The deformation element 11 can have a smaller material thickness and/or a material with a lower strength than the carrier 10. By action of a force on the second bearing point 15 in the guide 100 along the guide 100, which exceeds a predetermined minimum force, the deformation element 11 fails and is deformed, plastically in the example described here. The deformation element 11 thereby releases the guide 100 and permits a displacement of the second bearing point 15 along the guide 100. In the starting position of the second bearing point 15, the guide 100 is concealed by the deformation element 11. The deformation element 11 is oblong.

Optionally, the deformation element 11 has an (e.g. linearly, incrementally or exponentially) rising material thickness, strength and/or stability along its length. For example, people of different weights can be safely trapped. Before an end position in the guide 100, such a progression can be provided alternatively or in addition in order to prevent a hard impact.

Alternatively or additionally, the deformation element might also be formed by opposing edges of the guide 100. By exceeding the minimum force, the second bearing point 15 can bend the edges and thus provide for the displacement in the guide 100.

### LIST OF REFERENCE NUMERALS

1A, 1B crash device
10 carrier
100 guide
101 guideway
102, 103 housing sheet
104 opening
11 deformation element
110 weakened portion
12 arresting element
120 area (arm)
121 end
122 base
13 locking device
130 locking element
131A, 131B trigger element
132 propellant charge
133 igniter
134 receptacle
135 fastening area
136 web
137 protrusion
138 latch
139 spring
14 first bearing point
140 sleeve
141 opening
15 second bearing point
150 bearing bush
151 slide
152 opening
2 vehicle seat
20 seat part (component)
21 backrest
22 base (component)
23 fitting
24 height adjustment device
240, 241 swingarm
25 longitudinal adjustment device
250 seat rail
251 floor rail
26 seat belt
3 vehicle floor
F force
X longitudinal vehicle axis
Y transverse vehicle axis
Z vertical vehicle axis

1. A crash device comprising:
a first and a second bearing point for connecting one component each, and
a carrier on which the first bearing point is formed and which includes a guide for guiding a movement of the second bearing point relative to the first bearing point,
wherein in a starting position the second bearing point is arrested by an arresting element which is locked by means of a locking device and after unlocking of the locking device can be plastically deformed by a movement of the second bearing point along the guide.

2. The crash device according to claim 1, further comprising a deformation element which can be deformed relative to the first bearing point by a movement of the second bearing point guided on the guide out of a starting position.

3. The crash device according to claim 1, wherein the locking device and the arresting element each are mounted on the carrier in such a way that they cannot be moved without being destroyed, wherein a force acting on the arresting element can directly be introduced into the carrier via a first load path from the arresting element and via the locking device in the locked state can be introduced into the carrier via a second load path from the arresting element, and wherein by removing the second load path the arresting element can be weakened by means of unlocking of the locking device.

4. The crash device according to claim 1, wherein the arresting element is firmly attached to the carrier.

5. The crash device according to claim 1, wherein the arresting element includes an area which encloses the second bearing point in the starting position and can be plastically deformed by the movement of the second bearing point along the guide.

6. The crash device according to claim 1, wherein the locking device comprises a locking element fixed to the carrier, which in a locking position is in operative connection with the arresting element and can be transferred into an unlocking position in which the locking element is out of operative connection with the arresting element.

7. The crash device according to claim 5, wherein the locking device comprises a locking element fixed to the carrier, which in a locking position is in operative connection with the arresting element and can be transferred into an unlocking position in which the locking element is out of operative connection with the arresting element, the locking element includes a receptacle which in the locking position is in operative connection with an end of the area of the arresting element.

8. The crash device according to claim 6, wherein the operative connection of the locking element with the arresting element can be released by a deformation of the locking element.

9. The crash device according to claim 6, wherein the locking device comprises a trigger element by means of which the locking element can be transferred from the locking position into the unlocking position.

10. The crash device according to claim 9, wherein at least one of
the trigger element is configured in the form of a pyrotechnical actuator with an igniter and a propellant charge to be ignited by the igniter; and
the guide defines a guideway along which the movement of the second bearing point out of the starting position is guided relative to the first bearing point, wherein the trigger element is adapted to exert a force on the locking element at an angle to the guideway.

11. The crash device according to claim 1, wherein the carrier forms a housing in which the arresting element is arranged.

12. The crash device according to claim 1, wherein the carrier includes two housing sheets welded to each other.

13. The crash device according to claim 12, wherein the guide is configured in the form of an oblong hole in at least one of the housing sheets.

14. The crash device according to claim 1, wherein the second bearing point comprises a bearing bush which in the starting position is pressed into the arresting element.

15. The crash device according to claim 1, wherein at least one of the first bearing point and the second bearing point each are configured for rotatable mounting.

16. The crash device according to claim 1, wherein unlocking of the locking device is irreversible.

17. A vehicle seat comprising a seat part and a backrest, and comprising at least one crash device according to claim 1.

18. The vehicle seat according to claim 17, wherein the seat part is supported on a base via the crash device.

19. The vehicle seat according to claim 18, wherein the crash device is pivotally mounted on the base with one of the bearing points, and the seat part is pivotally mounted on the other one of the bearing points.

20. The vehicle seat according to claim 19, wherein the seat part is height-adjustably mounted relative to the base via the crash device.
